(19) United States
(12) Patent Application Publication
(10) Pub. No.: US 2007/0050268 A1
(43) Pub. Date: Mar. 1, 2007

(54) Matching CAD objects with relevant manufacturer-and supplier-supplied content leveraging pay-for-placement search engine technology

(76) Inventors: Charles S. Han, San Francisco, CA (US); Christopher Browne, San Rafael, CA (US)

Correspondence Address: SAWYER LAW GROUP LLP, P O BOX 51418, PALO ALTO, CA, 94303, US

(21) Appl. No.: 11/211,014

(22) Filed: Aug. 24, 2005

(51) Int. Cl. G06F 17/30

(52) U.S. Cl. 705/27

(57) ABSTRACT

A method integrated into a CAD application is disclosed for providing additional content related to CAD objects manipulated in the CAD application. Aspects of the present invention include automatically extracting a list of one or more attributes associated with the one or more CAD objects in response to a user interacting with the one or more CAD objects; sending the list attributes along with additional special keywords that identify that the CAD application is the source of the list to a pay-for-placement search engine; and receiving object content in a form that can be incorporated and displayed in the CAD application from the pay-for-placement search engine.

### FIELD OF THE INVENTION

The present invention relates to providing additional content related to objects manipulated in a software application using search technology, and more particularly to a method and system for matching computer-aided design (CAD) objects with manufacturer and supplier content in a CAD application.

### BACKGROUND OF THE INVENTION

A design process moves from conceptual to specific through a set of phases. For example, the architectural design process has been formalized into the following phases:

Phase I: Pre-Design (PD)

Phase II: Schematic Design (SD)

Phase III: Design Development (DD)

Phase IV: Construction Document Production (CD)

Much of the design process can be performed through the use of a computer-aided design (CAD) application, which generates a virtual design. As a designer moves through each phase of the design process using the CAD application, oftentimes the designer or user needs to acquire and incorporate new, alternative, supplemental, and more-refined content about the components or objects of the system being designed. While utilizing a conventional (CAD) application, the designer or any CAD application user is faced with several challenges when trying to procure this additional content related to the CAD objects.

CAD objects used to create or describe components or a system of components can have varying or even no schema to describe, classify and define the objects. Thus, searching for relevant content for these objects by leveraging search engine technology is highly dependent on the particular search algorithm. At the other end of the spectrum, some CAD applications use a formal model to define CAD objects. Use of such a model allows for highly-structured queries against a data source such as a database. However, retrieving new, alternative, supplemental, and more-refined content from such a data source is dependent on content providers adhering to the database schema and supplying content to the database. In addition, there are no formal mechanisms to handle data for objects that are outside the structure of CAD object model; or for content outside the database schema.

Accordingly, what is needed is a seamless, flexible system within a CAD application that provides the CAD user with contextually-relevant content about CAD objects. The present invention addresses such a need.

### BRIEF SUMMARY OF THE INVENTION

A method and system integrated into a CAD application is disclosed for providing additional content related to CAD objects manipulated in the CAD application. Aspects of the present invention include automatically extracting a list of one or more attributes associated with the one or more CAD objects in response to a user interacting with the one or more CAD objects; sending the list attributes along with additional special keywords that identify that the CAD application is the source of the list to a pay-for-placement search engine; and receiving object content in a form that can be incorporated and displayed in the CAD application from the pay-for-placement search engine.

According to the method and system disclosed herein, the present invention thus effectively matches CAD objects with relevant manufacturer- and supplier-supplied content to be incorporated into the CAD document providing value and efficiency to the CAD user and effectively targeting manufacturer and supplier product to a captive and buying audience. The use of a pay-for-placement search engine, as opposed to a non-pay-for-placement one, is significant because manufacturers and suppliers of goods represented by the CAD objects will be given incentive to provide relevant content for the CAD object attribute keywords via this advertising vehicle. The list of attributes sent to the search engine may include special keywords signaling to manufacturers and suppliers that the query originated from the CAD application. Thus, the manufacturers and suppliers have the opportunity to provide relevant CAD-application-specific content. Use of keywords and a pay-for-placement search engine as opposed to a database query against a database alleviates the restriction that content providers must adhere to the database schema to publish their content.

### BRIEF DESCRIPTION OF THE DRAWINGS

FIG. 1 is a block diagram illustrating a system for automatically providing additional content related to objects manipulated in a CAD application in accordance with a preferred embodiment of the present invention.

FIG. 2 is a flow diagram illustrating a process for automatically providing additional content related to the objects manipulated in the CAD application in accordance with the preferred embodiment of present invention.

FIG. 3 is a diagram illustrating an exemplary GUI window displayed by the CAD application on a display.

FIG. 4 is a diagram illustrating the CAD application window after the user has deselected the CAD object and refined the keyword list.

FIG. 5 is a diagram showing the CAD application window used independent of the initial extraction of attributes from the selected CAD object.

### DETAILED DESCRIPTION OF THE INVENTION

The present invention relates to a method and system for providing additional content related to objects manipulated in a software application using search technology. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a computer-aided design (CAD) application that effectively matches CAD objects with manufacturer- and supplier-supplied content relevant to the objects that the CAD application user is selecting, modifying, or adding to a CAD design. The CAD application of the present invention provides the manufacturer and supplier content by extracting and processing attributes of CAD objects and submitting the CAD object attributes to a pay-for-placement search engine. the CAD application then receives the additional content in a form that can be incorporated and displayed in the CAD application, such as pay-for-placement advertisements. The CAD application user may be presented with the list of CAD object attributes, and the CAD application user has the ability to either refine the list of keywords or create a list of keywords independent of the CAD objects in the CAD document. The CAD application user can then send this refined or new list to the pay-for-placement engine to generate and display refined or new content within the CAD application.

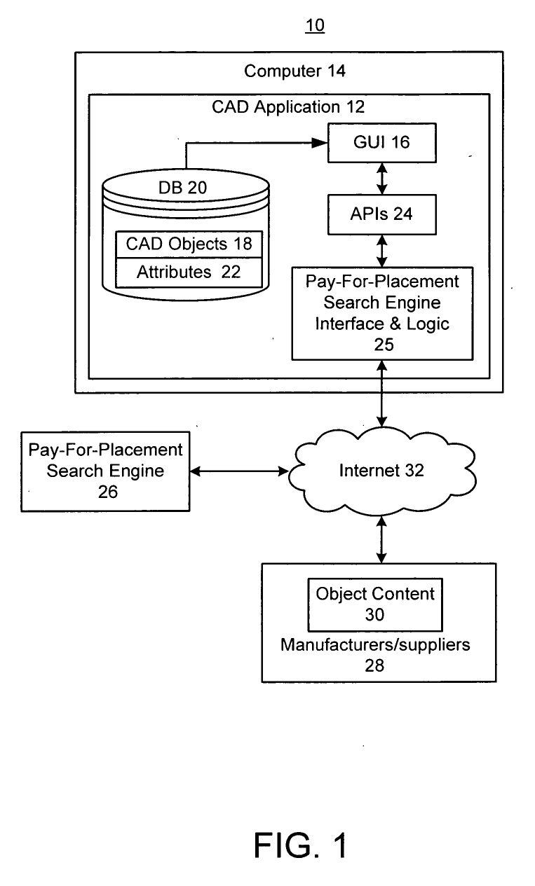

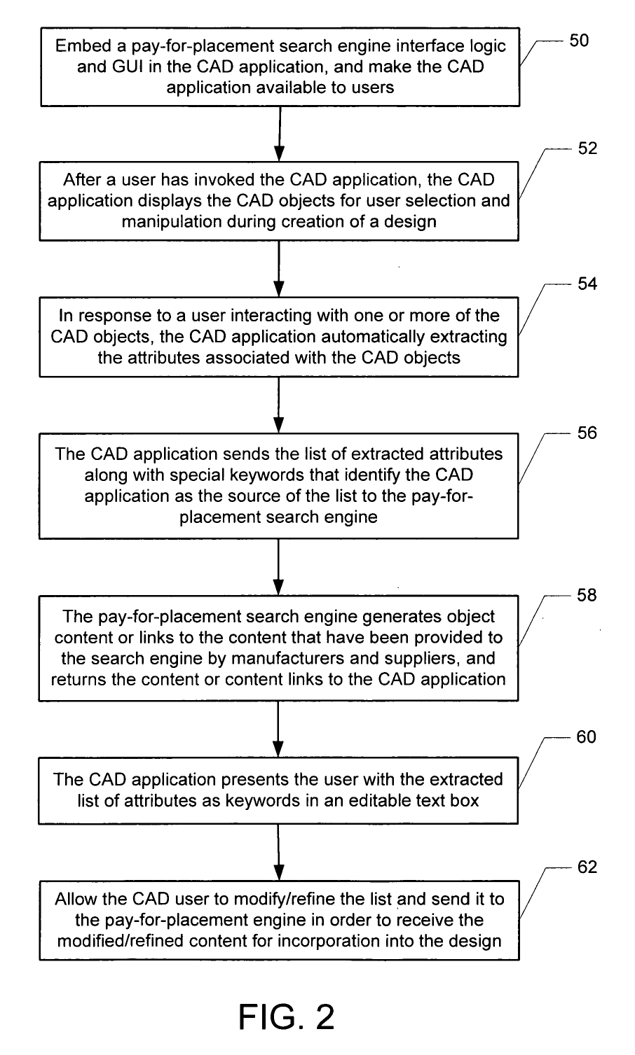

FIG. 1 is a block diagram illustrating a system for automatically providing additional content related to objects manipulated in a CAD application in accordance with a preferred embodiment of the present invention. The system 10 includes a CAD application 12 running on a computer 14. The CAD application 12 includes a graphical user interface (GUI) 16 in which a plurality of CAD objects 18 are displayed for user manipulation. The CAD objects 18 may be stored in a database 20, and each of the CAD objects is associated with a plurality of attributes 22 describing the respective object 18. The CAD application 12 further includes one or more application program interfaces (APIs) 24, which allows third-party developers to add behavior and functionality to the existing application 12. The CAD application 12 of the present invention leverages the following functionality provided through these APIs: 1) notification of events, specifically events that signal selection, modification, and addition of CAD objects 18, 2) extraction of the attributes 22 from CAD objects 18, 3) sending and receiving messages to external applications, and 4) creation of GUI components such as windows that display information, editable text boxes, and pushbuttons. The remaining components of the CAD system 12 will be described with reference to FIG. 2.

FIG. 2 is a flow diagram illustrating a process for automatically providing additional content related to the objects manipulated in the CAD application in accordance with the preferred embodiment of present invention. Referring to both FIGS. 1 and 2, the process begins in step 50 by embedding pay-for-placement search engine interface logic and GUI 25 in the CAD application 12 that communicates with a pay-for-placement search engine 26, and making the CAD application 12 available to users. The search engine interface 25 communicates with the pay-for-placement search engine 26 over a network 32, such as the Internet, using the CAD application APIs 24. Examples of commercially available pay-for-placement search engines 26 include YAHOO OVERTURE and GOOGLE ADWORDS/ADSENSE, for instance. Manufacturers and suppliers 28 provide object content 30 or content links relevant to keywords to the pay-for-placement search engine 26 over the network 32. It is this content 30 that is served to the CAD application 12 utilizing the search engine interface 25 for keywords that are transmitted from the CAD application 12, again utilizing the search engine interface 25, to the pay-for-placement search engine 26.

As will be appreciated by those with ordinary skill in the art, commercially available pay-for-placement search engines are typically used to provide relevant advertisements to web browser users in two ways: 1) When users actively search for content using specific keywords, pay-for-placement search engines allow advertisers to present advertisements for products relevant to those keywords, and 2) the pay-for-placement search engine results can also be embedded in web pages that contain relevant content. For example, GOOGLE ADWORDS/ADSENSE technology can present the user with advertisements for coffee and NOT advertisements about the island of Java or the Java programming language on a web page that has text passages containing the words “java,” “cup,” and “coffee” but does not contain the words “Indonesia,” “island,” “programming,” or “C++.”

Although in a preferred embodiment, the pay-for-placement search engine interface and logic 25 is embedded in a CAD application 12, the pay-for-placement search engine interface and logic 25 may be embedded in other types of software applications that enable users to manipulate graphical objects therein, such as the drawing program MICROSOFT VISIO, for instance. That is, the present invention enables manufacturers and suppliers 28 of goods represented by the CAD objects 18 to further maximize the return on advertising investment by the placement of pay-for-placement search engine technology in any computer applications where: 1) one of the by-products of using the computer application is the purchase of the product; 2) the computer application contains discrete application objects that are selected, added, or modified in the computer application; 3) the objects are relevant to products that lead to a purchase; and 4) advertisers can target these objects with relevant content.

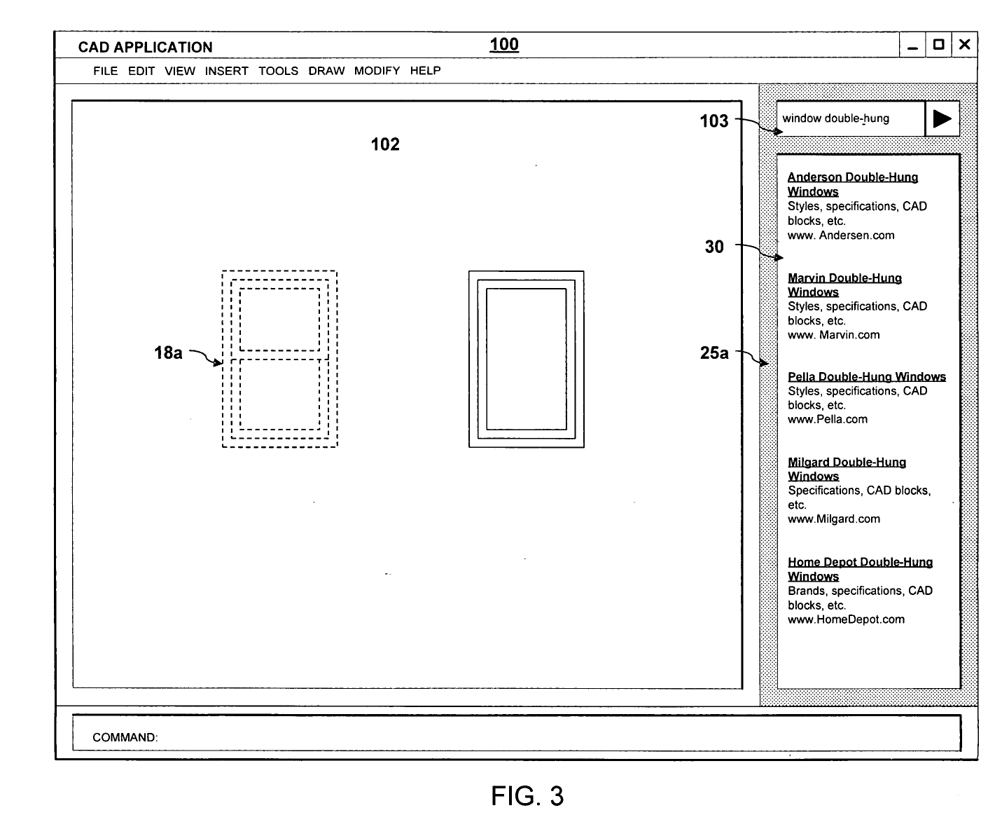

After a user has invoked the CAD application 12, in step 52 the CAD application 12 displays the CAD objects 18 for user selection and manipulation during creation of a design. FIG. 3 is a diagram illustrating an exemplary GUI window displayed by the CAD application 12 on a display. The GUI window 100 is shown comprising an object manipulation window 102 in which the objects 18 are displayed and/or added. The GUI window 100 also includes a pay-for-placement search engine interface GUI 25a that is directly incorporated into the CAD application window 100, as explained below. The underlying GUI 25a of the present invention can be realized by leveraging the CAD application APIs 24 as described above.

Referring again to FIG. 2, in response to a user interacting with one or more of the CAD objects 18 by creating, selecting, modifying, or adding the CAD objects 18 to the design, in step 54, the CAD application 12 of the present invention automatically extracts the attributes 22 associated with the CAD objects 18. Referring again to FIG. 3, an exemplary object 18a selected by the user is shown highlighted using a dashed-line representation in the object manipulation window 100. In step 56, the CAD application 12 sends the list of extracted attributes 22 along with special keywords that identify the CAD application 12 as the source of the list to the pay-for-placement search engine 26.

Referring again to both FIGS. 1 and 2, in step 58 the pay-for-placement search engine 26 uses the attribute and keyword list to generate links to relevant manufacturer- and supplier-supplied object content 30, that has been provided to the search engine 26 by the manufacturers/suppliers 28 targeting the list of keywords, and this content is returned and displayed in the pay-for-placement search engine interface GUI 25a. Alternatively, the actual object content 30, such as text, graphics, audio, film clips, or multi-media, may be displayed directly in the CAD application 12 in the search engine interface GUI 25a. Manufacturers suppliers 28 will have incentive to provide content 30 to the pay-for-placement search engine 26 for relevant keywords since these keywords will match attributes associated with the CAD objects 18, and they will be alerted by the special keywords appended to the list of attributes that the source of the query is from the CAD application 12 of the present invention.

In a further embodiment, in step 60, the CAD application 12 may present the user with the extracted list of attributes as keywords (e.g., “window” and “double-hung” without the special keywords) to allow the user to interactively refine the list of keywords. In a preferred embodiment, the CAD application 12 presents the attributes as keywords in an editable text box 103 in the displayed pay-for-placement search engine interface GUI 25a.

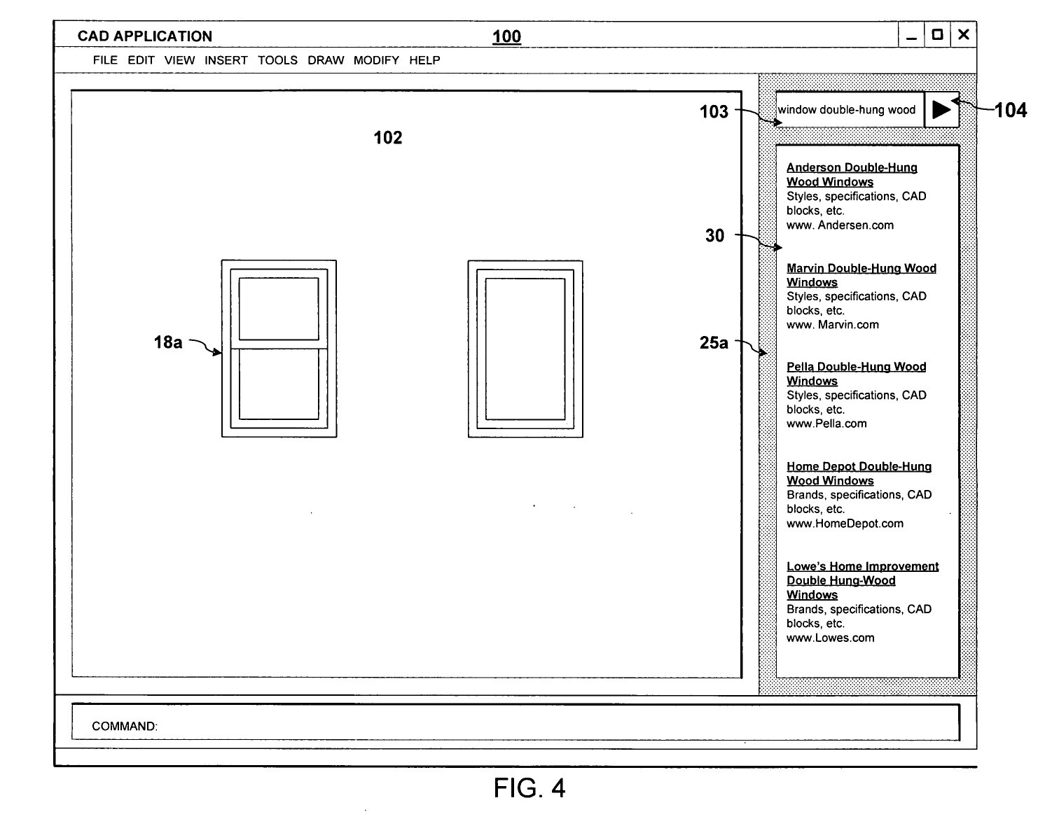

FIG. 4 is a diagram illustrating the CAD application window 100 after the user has deselected the CAD object. As shown in FIG. 4, the attribute keywords will be persisted in the editable text box 103 even if the CAD object 18a that generated the attributes is no longer selected. The keywords in the editable text box 103 in this example have been refined by the user with the inclusion of the keyword “wood”.

Referring to both FIGS. 2 and 4, in step 62, upon user-initiated re-submittal of the keywords to the pay-for-placement search engine 26 via some mechanism like a pushbutton 104 (again, appended with the additional special keywords), the relevant object content 30 supplied by the manufacturers and suppliers 28 is displayed in the pay-for-placement search engine interface GUI 25a along with the refined list of keywords displayed in the editable text box 103.

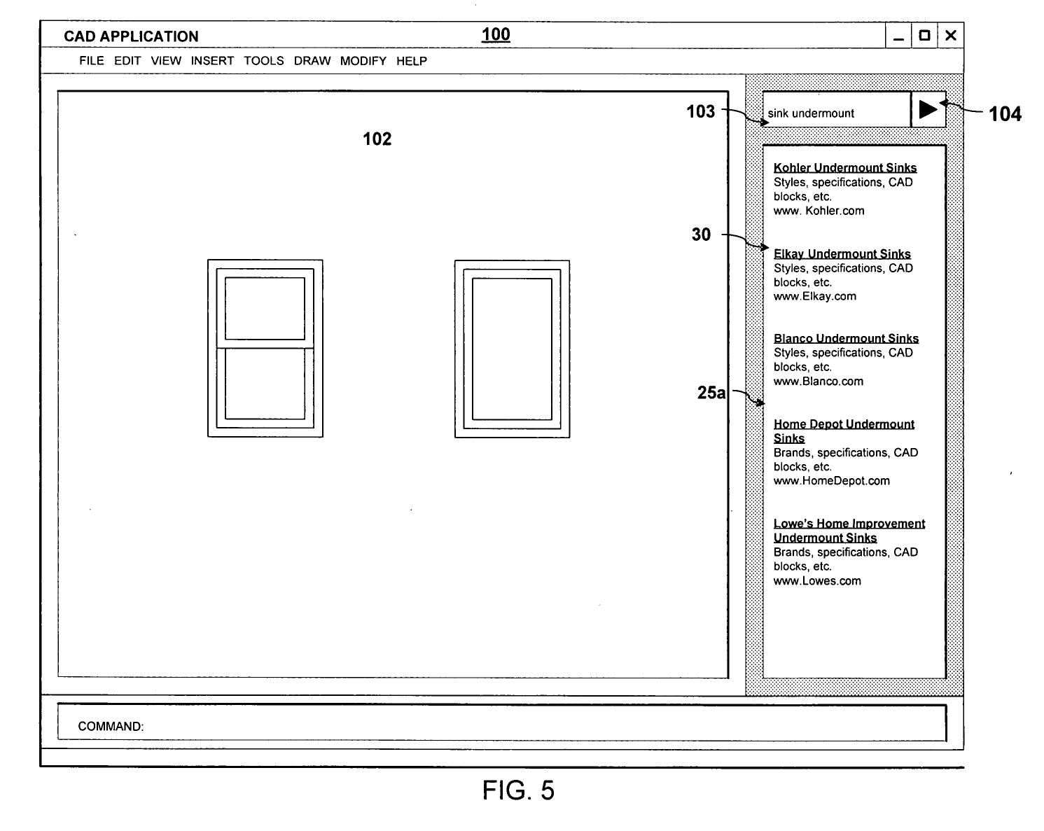

Finally, FIG. 5 is a diagram showing that the CAD application window 100 allows the user to submit user-defined keywords independently of the attributes initially extracted from the CAD objects 18a. The example shows that the user can simply type keywords in the editable text box 103, in this example the words “sink” and “undermount”, independent of the CAD objects in the CAD document, and submit the keywords to the pay-for-placement search engine 26 a mechanism such as the pushbutton 104.

Embedding the results of the pay-for-placement search engine 26 relevant to the CAD objects 18 into the CAD application 12 in the search engine interface GUI 25a in accordance with the preferred embodiment, enables manufacturers and suppliers 28 to maximize their return on advertising investment by presenting advertisements to a ready-to-buy audience, i.e., CAD users. Once manufacturers and suppliers 28 are aware that such an application 12 is being used to generate advertisements, which is achieved by sending the additional special keywords to the pay-for-placement search engine, advertisers may put relevant content in their advertisements that will give the CAD application user incentive to “click through” the advertisement. Thus, the marketplace will drive the generation and presentation of relevant content to the CAD application user.

A method and system for matching CAD application objects to relevant content provided by manufacturers and suppliers leveraging pay-for-placement search engine technology has been disclosed. Software written according to the present invention may be stored on a computer-readable medium, such as a removable memory, or transmitted over a network, and loaded into the computer for execution. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method integrated into a CAD application, the method comprising:
in response to a user interacting with one or more CAD objects, automatically extracting a list of one or more attributes associated with the one or more CAD objects;
sending the list attributes along with additional special keywords that identify that the CAD application is the source of the list to a pay-for-placement search engine; and
receiving object content in a form that can be incorporated and displayed in the CAD application from the pay-for-placement search engine.

2. The method of claim 1 further including embedding a pay-for-placement search engine interface and GUI within the CAD application.

3. The method of claim 1 wherein sending the list of attributes to the pay-for-placement search engine includes sending the list of attributes along with additional keywords that identify the CAD application as a source of the list.

4. The method of claim 1 further including extracting the attributes from the CAD objects in response to the user interacting with the CAD objects by one of creating, selecting, modifying, and adding the CAD objects to a design.

5. The method of claim 1 wherein displaying the object content includes returning links to the object content.

6. The method of claim 1 wherein receiving and displaying the object content includes displaying the actual object content.

7. The method of claim 1 further including:
presenting the user with the list of CAD attributes as keywords to allow the user to interactively refine the list of keywords; and
allowing user-initiated submittal of the refined list of keywords.

8. The method of claim 1 further including:
allowing the user to submit user-defined keywords independently of the attributes extracted from the CAD objects; and
allowing user-initiated submittal of the user-defined keywords.

9. The method of claim 1 wherein the CAD application displays a GUI window that comprises an object manipulation window for displaying the CAD objects for manipulation, and a pay-for-placement interface GUI for displaying the object content returned from the pay-for-placement search engine.

10. A computer-readable medium containing program instructions for automatically providing additional content related to objects manipulated in a CAD application, the program instructions for:
in response to a user interacting with one or more CAD objects, automatically extracting a list of one or more attributes associated with the one or more CAD objects;
sending the list attributes along with additional special keywords that identify that the CAD application is the source of the list to a pay-for-placement search engine; and
receiving object content in a form that can be incorporated and displayed in the CAD application from the pay-for-placement search engine.

11. The computer-readable medium of claim 1 further including embedding a pay-for-placement search engine interface and GUI within the CAD application.

12. The computer-readable medium of claim 1 wherein sending the list of attributes to the pay-for-placement search engine includes sending the list of attributes along with additional keywords that identify the CAD application as a source of the list.

13. The computer-readable medium of claim 1 further including extracting the attributes from the CAD objects in response to the user interacting with the CAD objects by one of creating, selecting, modifying, and adding the CAD objects to a design.

14. The computer-readable medium of claim 1 wherein displaying the object content includes returning links to the object content.

15. The computer-readable medium of claim 1 wherein receiving and displaying the object content includes displaying the actual object content.

16. The computer-readable medium of claim 1 further including:
presenting the user with the list of CAD attributes as keywords to allow the user to interactively refine the list of keywords; and
allowing user-initiated submittal of the refined list of keywords.

17. The computer-readable medium of claim 1 further including:
allowing the user to submit user-defined keywords independently of the attributes extracted from the CAD objects; and
allowing user-initiated submittal of the user-defined keywords.

18. The computer-readable medium of claim 1 wherein the CAD application displays a GUI window that comprises an object manipulation window for displaying the CAD objects for manipulation, and a pay-for-placement interface GUI for displaying the object content returned from the pay-for-placement search engine.
